(19) United States
(12) Patent Application Publication
(10) Pub. No.: US 2026/0168057 A1
(43) Pub. Date: Jun. 18, 2026

(54) HIGH-STRENGTH, FINE-GRAINED ALUMINUM ALLOY MICROSTRUCTURE AND METHOD FOR FABRICATING THE SAME

(71) Applicant: City University of Hong Kong, Hong Kong (HK)

(72) Inventors: Jian LU, Hong Kong (HK); Gan LI, Hong Kong (HK); Fucong LYU, Hong Kong (HK)

(21) Appl. No.: 18/983,418

(22) Filed: Dec. 17, 2024

(51) Int. Cl. C22C 21/06; B22F 10/28; B33Y 10/00; B33Y 30/00; B33Y 70/00; B33Y 80/00; C22C 1/04

(52) U.S. Cl. CPC C22C 21/06; B22F 10/28; C22C 1/0416; B33Y 10/00; B33Y 30/00; B33Y 70/00; B33Y 80/00

(57) ABSTRACT

The present invention provides a novel and efficient method for fabricating ultrahigh-strength bulk aluminum alloys with fine-grained microstructures and nanostructured strengthening defects. The alloy composition, AlxMgyScᵤZrᵥ, provides exceptional mechanical properties, with a yield strength of at least 656 MPa and an elongation of at least 7.2%. The microstructure includes ultrafine-grained (UFG), fine-grained (FG), and coarse-grained (CG) regions, which are optimized through laser powder bed fusion (L-PBF) manufacturing. The method enables precise control over the alloy's composition, microstructure, and mechanical properties, making it suitable for high-performance applications in industries requiring advanced material properties.

### FIELD OF THE INVENTION

The present invention generally relates to the technical field of additive manufacturing, specifically to the development of high-performance aluminum alloys with fine-grained microstructures and nanostructured strengthening defects for advanced structural applications.

### BACKGROUND OF THE INVENTION

Laser powder bed fusion (L-PBF) is a leading metal additive manufacturing (AM) technique that enables the rapid production of metallic parts with complex geometries. It has been used to manufacture high-performance materials such as steels, titanium alloys, and aluminum alloys, with the latter being highly sought after in industries like aerospace and electric automotive for their excellent strength-to-weight ratio, corrosion resistance, and abundance. However, high-strength wrought aluminum alloys face challenges in AM due to their tendency to crack during solidification, caused by their long solidification temperature range and residual stress.

To address these issues, fine-grained structures can be developed to improve resistance to hot-tearing and enhance mechanical strength. The fine-grained structure imparts a wealth of grain boundaries (GBs) to disrupt the stress arising during solidification, leading to higher resistance against hot-tearing and thus effectively suppressing cracks. The presence of a large number of GBs also impedes the dislocation mobility and augments the mechanical strength.

Inoculation treatments, such as adding lattice-matched nucleants or solutes with high growth restriction factors, have shown success in refining grain size and preventing cracks during L-PBF. Advances in alloying, including the addition of elements like Ti, Zr, Sc, Nb, and Ta have led to improved microstructures and mechanical properties in aluminum alloys. However, achieving a balance between strength and ductility remains a challenge.

Recent advances in high-performance alloys have highlighted the potential of nano-scale strengthening defects, such as twin boundaries and stacking faults (SFs), to improve mechanical properties. These defects enhance ductility by facilitating dislocation storage and plasticity, leading to a balance between strength and ductility. While this has been successful in alloys with low stacking fault energy (SFE), such as manganese steels and multi-principal element alloys, applying this strategy to aluminum alloys is challenging due to aluminum's high SFE (approximately 166 μmJ/m²). Tuning the SFE in aluminum is difficult, as most solute elements have limited solubility in aluminum. Nano-scale planar defects in aluminum have typically been achieved under extreme solidification or deformation conditions.

Therefore, there is a need for additively manufactured aluminum alloys with fine-grained structures and nanostructured strengthening defects that overcome the limitations of existing technologies.

### SUMMARY OF THE INVENTION

To address the above-mentioned shortcomings, a first aspect of the present invention provides a high-strength, fine-grained aluminum alloy microstructure, comprising an alloy composition of AlxMgyScᵤZrᵥ, in which 0.70≤x≤0.95, 0.04≤y≤0.20, 0.005≤u≤0.05, 0.005≤v≤0.05. The aluminum alloy microstructure exhibits a triple-modal grain distribution including ultrafine-grained (UFG) regions, fine-grained (FG) regions, and coarse-grained (CG) regions, and the aluminum alloy microstructure contains nano-scale planar defects, including stacking faults, nanotwins, and the 9R phase, distributed throughout an aluminum matrix. Each defect providing dislocation barriers that enhance mechanical strength and ductility.

In accordance with one embodiment, UFG regions have an average grain size of less than 500 nm and are positioned along the molten pool boundaries within the aluminum alloy microstructure. The FG regions have an average grain size ranging from 0.1 μm to 2 μm, and the CG regions have an average grain size ranging from 1 μm to 5 μm.

In accordance with one embodiment, the aluminum alloy microstructure further includes a dispersion of L1₂-ordered Al₃(Sc,Zr) nanoprecipitates distributed in the aluminum matrix, providing precipitation strengthening to the aluminum alloy microstructure. The L1₂-ordered Al₃(Sc,Zr) nanoprecipitates serve as heterogeneous nucleation sites during solidification, resulting in the triple-modal grain distribution.

In accordance with one embodiment, the CG regions exhibit limited dislocation mobility and enhanced resistance to crack propagation due to the presence of L1₂-ordered Al₃(Sc,Zr) nanoprecipitates.

In accordance with one embodiment, the nano-scale planar defects remain intact following direct aging treatment at approximately 300° C., thereby ensuring thermal stability.

In accordance with one embodiment, the aluminum alloy microstructure provides a relative density of at least 99%, as determined by micro-computed tomography analysis.

In accordance with one embodiment, the UFG regions, the FG regions, and the CG regions collectively contribute to a yield strength of at least 656 MPa and an elongation of at least 7.2% under a heat-treated condition.

In accordance with one embodiment, the 9R phase is stabilized by Mg-enriched regions in the aluminum matrix, which results from rapid solidification cycles inherent to the L-PBF process.

In accordance with one embodiment, the aluminum alloy microstructure is manufactured by laser powder bed fusion (L-PBF), the nano-scale planar defects are formed under rapid thermal cycles unique to the L-PBF process, which induce element segregation and promote formation of nanotwins and the 9R phase in Mg-enriched regions.

In accordance with one embodiment, the alloy composition further includes manganese (Mn), forming AlxMgyScᵤZrᵥ, wherein 0.70≤x≤0.95, 0.04≤y≤0.20, 0.01≤z≤0.05, 0.005≤u≤0.05, 0.005≤v≤0.05.

In a second aspect, the present invention provides a method for fabricating a high-strength, fine-grained aluminum alloy microstructure with nanostructured strengthening defects, including: preparing one or more alloy powder comprising aluminum (Al), magnesium (Mg), scandium (Sc), and zirconium (Zr); melting the one or more alloy powder on a preheated substrate using a laser powder bed fusion (L-PBF) process with a laser power of 300-400 W and scan speed of 800-2000 μmm/s to induce rapid cooling and grain refinement, resulting in the formation of nano-scale planar defects; and forming a triple-modal grain distribution across as-printed aluminum alloy to obtain the high-strength, fine-grained aluminum alloy microstructure.

In accordance with one embodiment, the nano-scale planar defects and the triple-modal grain distribution are preserved after the direct treatment at 300° C. for 4 hours.

In accordance with one embodiment, the nano-scale planar defects include stacking faults, nanotwins, and the 9R phase, and the triple-modal grain distribution includes CG regions, FG regions and UFG regions.

In accordance with one embodiment, the triple-modal grain distribution results from unevenly distribution of L1₂-ordered Al₃(Sc,Zr) nanoprecipitates, which form a coherent interface with an aluminum matrix and therefore promote heterogeneous nucleation of α-Al during solidification of melt pools in the PBF-LB process, and the L1₂-ordered Al₃(Sc,Zr) nanoprecipitates are mainly formed in the UFG regions.

In accordance with one embodiment, the one or more alloy powder further contains manganese (Mn).

In accordance with another embodiment, the one or more alloy powder contains 70-95 wt % of Al, 4-18 wt % of Mg, 1-5 wt % of Mn, 0.5-5 wt % of Sc, and 0.5-5 wt % of Zr.

In accordance with one embodiment, the preheat temperature of the substrate is in the range of room temperature to 200° C., and the substrate comprises various grades of Al alloys.

Combining SFs and nanotwins with other strengthening mechanisms, such as grain boundary and precipitate strengthening, presents a promising approach to achieving both high strength and ductility in additively manufactured aluminum alloys using L-PBF. The present invention successfully develops an additively manufactured fine-grained high-performance Al—Mg—Mn—Sc—Zr alloy nano-structured with strengthening planar defects through L-PBF. Tailored planar defects comprising stacking faults, 9R phase, ultrafine grains (UFG) and nanotwins are strategically introduced in the as-printed alloy to realize remarkable mechanical strength-ductility combination in both as-printed and heat-treated states.

Beyond the nano-scaled planar defects and the triple-modal grain distribution, further direct ageing process augments the abundance of nanoprecipitates. The heat-treated alloy with extensive nanoprecipitations has an outstanding yield strength of up to 656 MPa, surpassing any previously reported values for Al alloys produced via L-PBF, while still maintaining a moderate ductility of 7.2%.

The present invention opens the door for near-net-shape fabrication of high-performance aluminum alloy components for advanced structural applications. These lightweight components are ideal for mechanical load-bearing in industries such as aerospace, automotive, shipbuilding, as well as in communication and electronic products.

### BRIEF DESCRIPTION OF THE DRAWINGS

Embodiments of the invention are described in more details hereinafter with reference to the drawings, in which:

FIG. 1 shows diffusivities and maximum equilibrium solid solubility of alloying elements in Al at elevated temperature;

FIG. 2A shows a schematic representation of the unit cells for FCC-Al and L1₂-Al₃Sc.

FIG. 2B shows a schematic representation of the unit cells for FCC-Al and L1₂-Al₃Zr;

FIG. 3A shows the interatomic misfit and the mismatch in interplanar spacing between the FCC-Al and L1₂-Al₃Sc. FIG. 3B shows the interatomic misfit and the interplanar spacing mismatching between the FCC-Al and L1₂-Al₃Zr;

FIG. 4 shows Scheil-Gulliver solidification curves of the Al—Mg—Mn and Al—Mg—Mn—Sc—Zr alloys, showing approximately 5% (by mole fraction) of nucleation particles L1₂-Al₃(Sc, Zr) precipitated during the incipient stage of the solidification in the Al—Mg—Mn—Sc—Zr alloy;

FIG. 5 shows a diagrammatic sketch of the rapid solidification processes for Al—Mg—Mn and Al—Mg—Mn—Sc—Zr alloys during L-PBF, illustrating the grain refinement mechanism and crack behavior;

FIG. 6 shows an overview of L-PBF process, a SEM morphological image of raw alloy powders with some satellite powders on the surface, reconstructed μ-CT results of the as-printed alloy showing the densification behavior of the as-printed Al—Mg—Mn—Sc—Zr alloy, statistics of the internal pore size distribution and the degree of sphericity distribution in the as-printed Al—Mg—Mn—Sc—Zr alloy, and optical isometric macrograph of the as-printed Al—Mg—Mn—Sc—Zr alloy;

FIG. 7 shows a longitudinal EBSD inverse pole figure (IPF) color image of the as-printed Al—Mg—Mn—Sc—Zr alloy;

FIG. 8A shows longitudinal EBSD images of the as-printed Al—Mg—Mn—Sc—Zr alloy.

FIG. 8B shows SEM images of the as-printed Al—Mg—Mn—Sc—Zr alloy;

FIG. 9 shows the grain size distribution of the as-printed Al—Mg—Mn—Sc—Zr alloy, with an inset displaying the pole figures;

FIG. 10A shows bright field TEM characterization of the as-printed sample, highlighting the triple-modal grain size distribution (i.e., UFG, fine-grained (FG), and coarse-grained (CG)). FIGS. 10B-10C show High-angle annular dark-field scanning transmission electron microscopy (HAADF-STEM) image of the cubic particles within the grain, and corresponding EDS map. FIG. 10D shows high-resolution TEM (HRTEM) image taken at the α-Al/L1₂-Al₃(Sc, Zr) interface along the <001> Al zone axis and corresponding fast Fourier transform (FFT) pattern. FIG. 10E shows X-ray diffraction patterns of the as-printed and heat-treated Al—Mg—Mn—Sc—Zr alloy;

FIG. 11 shows STEM-EDS maps of the main elements (Al, Mg, Mn, Sc, Zr) in different regions, including UFG region, UFG+FG regions and UFG+FG+CG regions. BD: building direction;

FIG. 12 shows ultrafine cells approximately 200 nm in size, with Al₃(Sc, Zr) particles serving as heterogeneous nucleation sites within the grains of the as-printed Al—Mg—Mn—Sc—Zr alloy;

FIG. 13A shows a representative TEM image showing the twin boundary within one grain. FIG. 13B shows a representative HRTEM image showing the coexistence of the nanotwins and 9R phase. FIGS. 13C-13D show enlarged HRTEM images in FIG. 13B, showing the coherent twinning boundary (CTB). FIG. 13E shows an enlarged HRTEM image in FIG. 13B, showing the nanotwins and various regions of the 9R phase. FIG. 13F shows a HRTEM image of the 9R phase. The inset schematically indicates that the 9R phase comprises of nine {111}atomic layers with an . . . ABC/BCA/CAB/A . . . stacking sequence;

FIG. 14 shows a TEM microstructure of the as-printed Al—Mg—Mn—Sc—Zr alloy, taken along the [110] zone axis for fcc-Al, highlighting the twin boundary and fine precipitates;

FIG. 15A shows a 3D reconstruction of the atom map derived from the atom probe tomography (APT) results. FIG. 15B shows an elemental distribution profile across the Al matrix and the Sc/Zr-rich region. FIG. 15C shows an elemental distribution profile across the Al materix and Mn rich region. The insert shows the isosurface analysis of Sc and Mn, respectively;

FIG. 16A shows 3D reconstruction of the atom map from the APT measurement showing the intragranular chemical composition distribution (Al, Mg, Mn, Sc, Zr) of the as-printed Al alloy. FIG. 16B shows elemental concentration profiles across the entire sample, with the inset showing the isosurface analysis of the Mg element (5 at %). The error bands represent the standard deviation of the mean. Note that the TEM images were captured along the <110> zone axis of Al;

FIG. 17 shows A HRTEM image of heat-treated Al—Mg—Mn—Sc—Zr alloy and the corresponding FFT patterns showing an intermingling structure of Al matrix, SFs, twin and 9R phase;

FIG. 18 shows a longitudinal EBSD inverse pole figure (IPF) color image of the heat-treated Al—Mg—Mn—Sc—Zr alloy;

FIG. 19 shows an EBSD pole figure (PF) image along with the grain size distribution of the heat-treated Al—Mg—Mn—Sc—Zr alloy;

FIG. 20A shows TEM characterization of the heat-treated sample, revealing a significant number of precipitates. FIG. 20B shows a HAADF-STEM image along with the corresponding energy dispersive spectroscopy (EDS) mapping, illustrating the distribution of elements. FIG. 20C shows a bright-field TEM image and corresponding EDS mapping results of the heat-treated Al—Mg—Mn—Sc—Zr alloy;

FIG. 21A shows a HRTEM image of the L1₂-ordered Al₃(Sc, Zr). FIG. 21B shows a HRTEM image and the corresponding FFT image of the D1a-ordered Al₄(Sc,Zr)(Ni₄Mo type);

FIG. 22A shows typical engineering tensile stress-strain curves of the L-PBFed Al—Mg—Mn—Sc—Zr alloys. FIG. 22B shows a comparison of the mechanical properties of the present L-PBFed Al—Mg—Mn—Sc—Zr alloys with other L-PBFed Al alloys (including Al—Si alloys, modified wrought alloys and high-strength Al alloys tailored for L-PBF) and conventional wrought Al alloys (including 2xxx, 6xxx and 7xxx series high-strength alloys). The symbol “+” indicates the powders externally added through mechanical mixing or ball milling while the symbol “−” means the in-situ formed particles (pre-alloy powders);

FIG. 23A shows the as-printed longitudinal sample. FIG. 23B shows the as-printed transverse sample. FIG. 23C shows heat-treated longitudinal sample. FIG. 23D shows heat-treated transverse sample;

FIG. 24A shows true tensile stress-strain curves of the L-PBFed Al—Mg—Mn—Sc—Zr alloy. FIG. 24B shows work hardening behavior of the L-PBFed Al—Mg—Mn—Sc—Zr alloy; and

FIG. 25A shows as-printed Al—Mg—Mn—Sc—Zr alloy. FIG. 25B shows heat-treated sample.

### DETAILED DESCRIPTION OF THE INVENTION

The present invention will be described in detail through the following embodiments with appending drawings. It should be understood that the specific embodiments are provided for an illustrative purpose only, and should not be interpreted in a limiting manner. Those skilled in the art will appreciate that the invention described herein is susceptible to variations and modifications other than those specifically described.

The invention includes all such variations and modifications. The invention also includes all of the steps and features referred to or indicated in the specification, individually or collectively, and any and all combinations or any two or more of the steps or features. Other aspects and advantages of the invention will be apparent to those skilled in the art from a review of the ensuing description.

Uniting high strength and superior ductility for intricately shaped aluminum (Al) alloy parts represents challenging yet essential to satisfying the ever-increasing requirements of the lightweight designs and carbon neutrality. Especially, the additively manufactured Al alloys have been widely used in a wide range of advanced engineering applications due to the low density, superior mechanical performance and corrosion resistance. Currently, the common Al alloys used for additive manufacturing are Al—Si series alloys such as AlSi₇Mg, AlSi₁₀Mg and AlSi₁₂ alloys, which exhibit good processability but relatively lower mechanical strength. Thus, developing new high-performance Al alloys with a satisfactory balance of strength and ductility is highly desirable, which can further realize energy conservation and emission reduction.

In response to the growing demand for lightweight materials and carbon neutrality, the present invention introduces an innovative ultrafine-grained Al—Mg—Mn—Sc—Zr alloy or ultrafine-grained Al—Mg—Sc—Zr alloy, reinforced with nano-structured planar defects. This alloy is produced using L-PBF technology and is specifically designed for complex-shaped components that require exceptional strength and superior ductility.

In particular, the present invention provides a high-strength, fine-grained aluminum alloy microstructure, comprising an alloy composition of AlxMgyScᵤZrᵥ, in which 0.70≤x≤0.95, 0.04≤y≤0.20, 0.005≤u≤0.05, 0.005≤v≤0.05. The aluminum alloy microstructure exhibits a triple-modal grain distribution including UFG regions, FG regions, and CG regions, and the aluminum alloy microstructure contains nano-scale planar defects, including stacking faults, nanotwins, and the 9R phase, distributed throughout an aluminum matrix.

Mg is present in a concentration effective for reducing stacking fault energy in the aluminum matrix, facilitating the formation of nano-scale planar defects during the L-PBF process.

Owing to the uneven distribution of the L1₂-ordered Al₃(Sc, Zr) nanoparticles, the as-printed alloy demonstrates a hierarchically heterogeneous microstructure featuring a triple-modal grain distribution, including the UFG region at the MP boundary, as well as the FG region and UG region toward the MP center.

The present invention also provides a method of fabricating an ultrahigh-strength aluminum alloy with a fine-grained microstructure and nanostructured strengthening defects. The method employs a powder bed fusion using a laser beam (PBF-LB) technique, wherein the one or more alloy powder is used as raw material. After that the one or more alloy powder is melted on a preheated substrate using a laser powder bed fusion (L-PBF) process to induce rapid cooling and grain refinement, resulting in the formation of nano-scale planar defects. Then, a triple-modal grain distribution formed across as-printed aluminum alloy to obtain the high-strength, fine-grained aluminum alloy microstructure.

The raw materials are selectively melted using a laser beam to build the component layer by layer. The laser power and scan speed are optimized to achieve a nearly fully dense and crack-free aluminum alloy with a fine-grained microstructure. The alloy powders used in the present invention include at least aluminum (Al), magnesium (Mg), scandium (Sc), and zirconium (Zr), with the specific weight percentages of these elements being controlled to ensure the formation of the desired microstructure and strengthening defects. The formation of these strengthening defects was induced by the unique solidification process of PBF-LB and high Mg content in Al alloy that can significantly reduce the stacking fault energy of the Al.

Optionally, the alloy powders used in the present invention further contains manganese (Mn), forming AlₓMg_{y}ScᵤZr_{y}, wherein 0.70≤x≤0.95, 0.04≤y≤0.20, 0.01≤z≤0.05, 0.005≤u≤0.05, 0.005≤v≤0.05.

The process parameters are carefully controlled to achieve the fine-grained microstructure, which includes a triple-modal grain distribution. This distribution is induced by the unevenly distributed L1₂-ordered Al₃(Sc,Zr) nanoparticles, which act as heterogeneous nucleation sites during the solidification of the melt pools. These nanoparticles, primarily located in the UFG regions, form a coherent interface with the Al matrix, promoting the formation of distinct CG, FG, and UFG regions in the final microstructure. This distribution of grains contributes to the high strength and toughness of the alloy.

The key parameters of the PBF-LB process are critical in controlling the material properties. Laser power must be optimized to regulate the melt pool and achieve full density in the part. The scan speed is adjusted based on the desired cooling rate and thermal gradients, influencing the solidification process. Hatch spacing plays a significant role in layer fusion and directly impacts the overall microstructure. Additionally, layer thickness is crucial for precise control over material deposition and cooling, allowing for fine adjustments in the final structure.

In one embodiment, the laser power during the PBF-LB process is in the range of 200-400 W.

In one embodiment, the scan speed during the laser PBF-LB process is in the range of 500-3000 μmm/s.

In one embodiment, the hatch space during the laser PBF-LB process is in the range of 0.05-0.2 μmm.

In one embodiment, the layer thickness of the powers during the laser PBF-LB process is in the range of 0.02-0.05 μmm.

In one embodiment, the grain structure has an average grain size of less than 500 nm. These fine grains are surrounded by cyclic modules that provide an additional level of structural complexity, enhancing the strength and durability of the alloy.

In one embodiment, the substrate used in the PBF-LB process can be any suitable aluminum alloy, such as 2024 Al or 6061 Al, to support the growth of the ultrahigh-strength alloy. The process is conducted under an inert atmosphere, using argon gas with a purity of 99% to 100%, ensuring that oxidation and contamination are minimized.

The nano-sized strengthening defects, including stacking faults, nanotwins, and the 9R phase, are formed through the unique solidification process of the PBF-LB technique. High Mg content in the aluminum alloy is key to reducing the stacking fault energy, promoting the formation of these strengthening defects. The PBF-LB process enables the formation of these defects at a nanoscale level, which significantly improves the material's mechanical properties, such as tensile strength and resistance to fatigue.

In one embodiment, the method includes a heat treatment step at 300° C. for 4 hours, which is critical for preserving both the nano-sized strengthening defects and the triple-modal grain distribution. This treatment does not significantly affect the defects formed during the PBF-LB process, ensuring that the ultrahigh-strength properties of the alloy are maintained after fabrication.

The method can produce bulk aluminum alloys with a minimum size of 1 cm (length)*1 cm (width)*1 cm (height), which is suitable for various structural applications.

The following examples illustrate the present invention and are not intended to limit the same.

### EXAMPLE

### Example 1—Materials and Methods

### Sample Preparation

A SLM Solutions SLM280 commercial printer with dual-laser system is used for the L-PBF process. The adopted optimized parameters are a laser power (P) of 370 W, a scan speed (v) of 1260 μmm/s, a hatch space (h) of 140 μmm, a layer thickness (t) of 30 am, and a standard alternating x/y raster scan patten with 67° rotation between consecutive layers.

The laser energy input (E) is calculated according to the volumetric energy density formula:

$$E = \frac{P}{v h t} ,$$

Cubic samples (10 μmm×10 μmm×10 μmm) are built for densification and microstructural analyses while cylinder samples (17 μmm in diameter and 76 μmm in height) along both transverse and longitudinal directions are printed for tensile tests. The samples are prepared on a 6061 Al alloy substrate under the protective environment of high-purity argon (99.999%). The substrate is not preheated, to realize the cost, energy, and time savings while reducing the complexity of the printing process. The optimized heat treatment is a direct ageing process that is carried out at 300° C. for 4 h.

### Densification, Microstructural and Mechanical Characterization

A cubic specimen with a side length of approximately 2.5 μmm taken from the as-printed sample is used to detect the densification behavior using a GE-Phoenix micro-focus computed tomography (μ-CT) machine operated at 190 kV and 20 a. A spatial resolution of 2024×2024 pixels and a CT scan step size of 0.2° are used for rotation ranging from 0° to 360° to obtain the raw data. The VGSTUDIO Max 3.2 software is then utilized to reconstruct the 3D data field to reveal the internal defect characteristics (i.e., the size, distribution and degree of sphericity of the pores in this study) and overall relative density.

The degree of sphericity (Dₛ) is evaluated using the ratio of the surface area of a pore (Aₛ) to the surface area of a density hot spot (A_{dhs}). It is clear that a higher value of Dₛ corresponds to a pore being more spherical. The volumes of the pore and the density hot spot are equal, that is:

$${D}_{s} = \frac{{A}_{s}}{{A}_{d h s}} ,$$

A Zeiss Axio Observer 3 optical microscope (OM) is used to investigate the macrostructure features of the as-printed samples. The morphology of the feedstock powders is captured using a Thermo Scientific Apreo2 field-emission scanning electron microscope (FESEM) while the microstructure of the L-PBFed samples is characterized by a FEI Talo F200× transmission electron microscopy (TEM) equipped with EDS detectors and operated at an accelerating voltage of 200 kV. An electron back-scattered diffraction (EBSD), mounted on the Apreo 2 SEM, is used with a step size of 70 nm to obtain the grain size and orientation information.

Needle-shaped specimen required for atom probe tomography (APT) is fabricated by lift-outs and annular milled in a FEI Scios focused ion beam/scanning electron microscope (FIB/SEM). The APT characterizations of the as-printed sample are carried out in a local electrode atom probe (CAMEACA LEAP 5000 XR). The specimen is analyzed at 70 K in voltage mode, at a pulse repetition rate of 200 kHz, a pulse fraction of 20%, and an evaporation detection rate of 0.2% atom per pulse. The data analysis workstations AP Suite 6.3 is used for creating the 3D reconstructions and data analysis.

Tensile tests are conducted along both transverse and longitudinal directions to verify isotropy using the rod tensile specimens with the gauge dimensions of 25 (length)×5 μmm (diameter). An Instron 3382 μmachine is used at a constant strain rate of 1 μmm/min in tensile tests at ambient temperature.

### Thermodynamic Calculations

In investigating the solidification process for Al alloys, the Thermo-Calc software (version 2020b) software with an Al database (TCAL5: Al alloys, version 5.1) is used to calculate the solidification paths of the Al—Mg—Mn and the Al—Mg—Mn—Sc—Zr alloys. As the solidification behavior during the L-PBF process is far away from that of the equilibrium state, a Scheil-Gulliver solidification model calculation (classic Scheil simulation) is performed in this invention. In general, Al itself is a high-diffusivity metal and the solutes Mn, Sc and Zr have a significant lower diffusion coefficient in Al matrix while Mg has a slightly higher diffusion coefficient. In addition, the solutes in the newly developed Al alloy (Mg, Mn, Sc and Zr) do not dissolve interstitially in Al, in contrast with the carbon in the steels, and there are thus no elements that are considered as the fast diffusers. The following assumptions are therefore made for the Scheil simulation:
(i) Diffusion in the liquid phase is assumed to be very fast, that is, infinitely fast.
(ii) Diffusion in the solid phases is so slow that it can be ignored.
(iii) The liquid/solid interface is in thermodynamic equilibrium.
   There is thus no diffusion in the solid phase and infinitely fast diffusion of all elements in the liquid phase. In the simulations, the temperature is reduced in steps of 0.1° C. and the mole fraction of the solid of the alloy is calculated with respect to temperature.

### Example 2

### Design and Optimization of Mg-Modified Al Alloys for Enhanced Nano-Scaled Planar Defects in L-PBF Process

To improve the formation of nano-scale planar defects such as SFs and nanotwins in L-PBFed aluminum alloys, the SFE of aluminum must be reduced. In this example, magnesium (Mg) is chosen as the solute due to its high solubility at elevated temperatures (up to 17.1 wt % at 450° C.), low solubility at room temperature (near zero), and its effectiveness in reducing the SFE of aluminum. Previous first-principles calculations have demonstrated that Mg moderately reduces the SFE of aluminum, within the limits of its solubility. As a result, the rapid solidification process of L-PBF offers significant potential for creating a supersaturated solid solution and nano-scale planar defects in as-printed aluminum alloys when a high Mg content is used.

To further validate this design strategy, the 5083 Al alloy (Al—Mg—Mn) is selected as the base alloy in the present invention due to its high Mg content (4.0 to 4.9 wt %). The Mg content in the alloy powder is adjusted to the upper limit of the standard composition to account for magnesium loss during the powder preparation process, and preferential evaporation during L-PBF due to its low melting point.

### Example 3

### Grain Refinement and Hot Crack Suppression in L-PBF Al Alloys Through Sc/Zr Alloying and Inoculation Treatment

To achieve significant grain refinement and prevent hot cracking, an inoculation treatment is performed by introducing effective nucleants. After a thorough examination of common elements in Al alloys, Sc is selected as the most important alloying element for forming the L1₂-ordered phase.

Sc is the only transition element capable of forming a thermodynamically stable Al₃Sc phase with an L1₂-ordered structure. However, other Al₃X systems, such as Al₃Ti and Al₃Zr, may transform from the L1₂ structure into different allotropes at ambient temperatures.

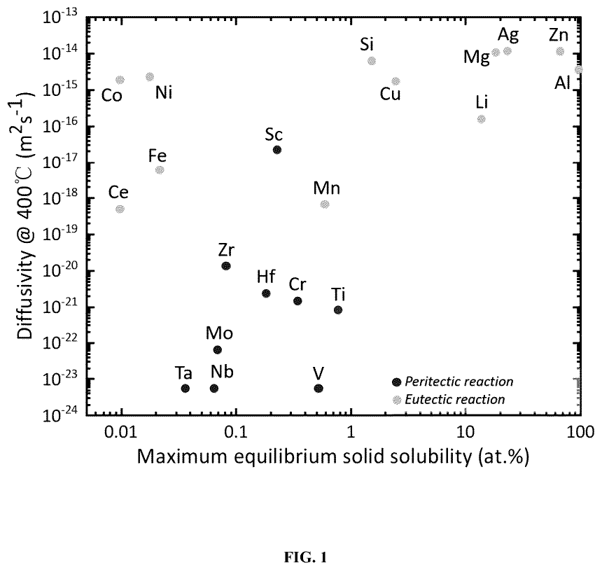

Due to the relatively high diffusion rate of Sc in Al (FIG. 1), Al₃Sc is prone to coarsening at elevated temperatures (e.g., 300-400° C.). To counteract this, Zr is added to Al, as it has a low diffusion rate in Al, which helps prevent coarsening by promoting the in-situ formation of a L1₂-ordered Sc/Zr-rich phase, Al₃(Sc, Zr).

Moreover, given the significant impact of atomic matching between the L1₂ phase and the Al matrix on promoting effective nucleation, it is essential to quantitatively evaluate this matching. The crystallographic matching is quantitatively calculated based on the edge-to-edge model (E2EM) to guide the formation of ultrafine-grained microstructure.

The efficiency of a nucleant is influenced by factors such as size, interfacial energy, and the wetting behavior of the melt. Atomic matching, or lattice disregistry (denoted by δ), is used to assess nucleant effectiveness. A lower δ value indicates lower interfacial energy, leading to better grain refinement. A low atomic mismatch suggests a coherent or semi-coherent interface, indicating a reproducible orientation relationship between the matrix and nucleant.

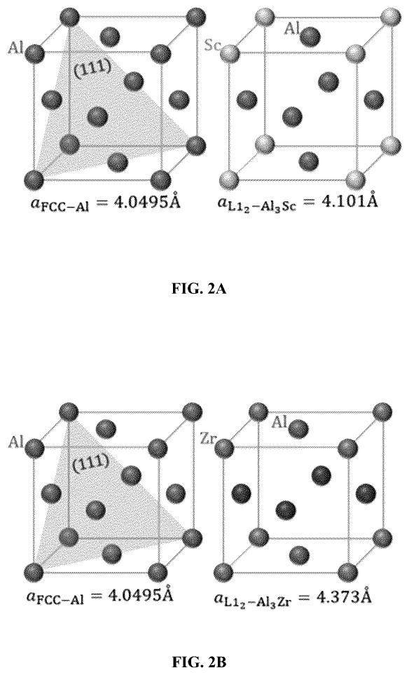

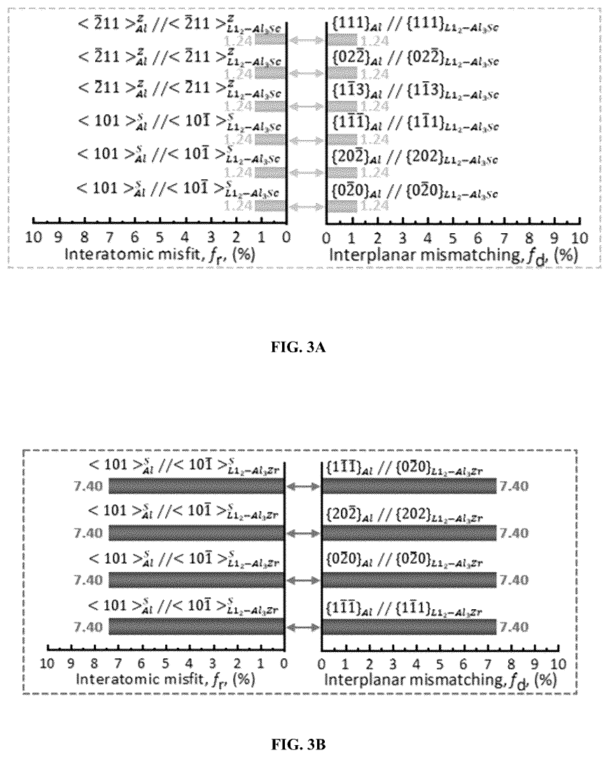

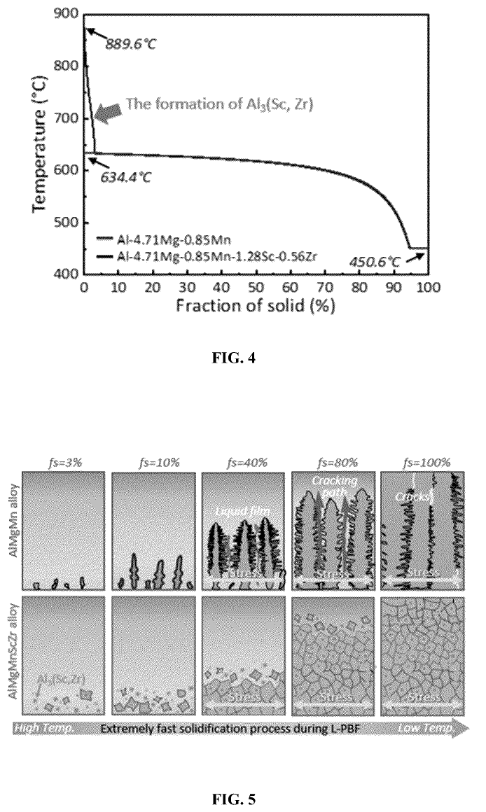

To evaluate the L1₂-ordered Al₃(Sc, Zr) compounds as grain refiners, lattice characteristics are calculated. As schematically displayed in FIGS. 2A-2B, both L1₂-Al₃Sc and L1₂-Al₃Zr phases have an face-centered cubic (FCC) structure and lattice parameters (a) similar to pure Al, ensuring good atomic matching at the L1₂-Al₃Sc/Al interface. E2EM calculations consider crystal structure, lattice parameters, and atomic positions, evaluating close-packed (CP) atomic rows and planes. The interatomic spacing misfit (fᵣ) and interplanar spacing mismatch (f_{d}) must be below 10% for an energetically favorable orientation relationship (OR). For example, the CP rows and planes of Al and L1₂-Al₃Sc match well, with very small fᵣ and f_{d} values (both 1.24%), indicating that L1₂-Al₃Sc is an effective nucleant for Al (FIG. 3A). Similarly, L1₂-Al₃Zr also shows good nucleating potential, with small fr (7.4%) and f_{d} (7.4%) values, confirming its effectiveness as a nucleant (FIG. 3B). Therefore, from a crystallographic standpoint, L1₂-Al₃(Sc, Zr) can act as a highly effective nucleant, resulting in substantial grain refinement. This grain refinement also plays a crucial role in preventing the initiation and propagation of hot cracks during L-PBF (FIGS. 4-5).

### Example 4

### Characterization of the Additively Manufactured Fine-Grained Ultrahigh-Strength Bulk Aluminum Alloys

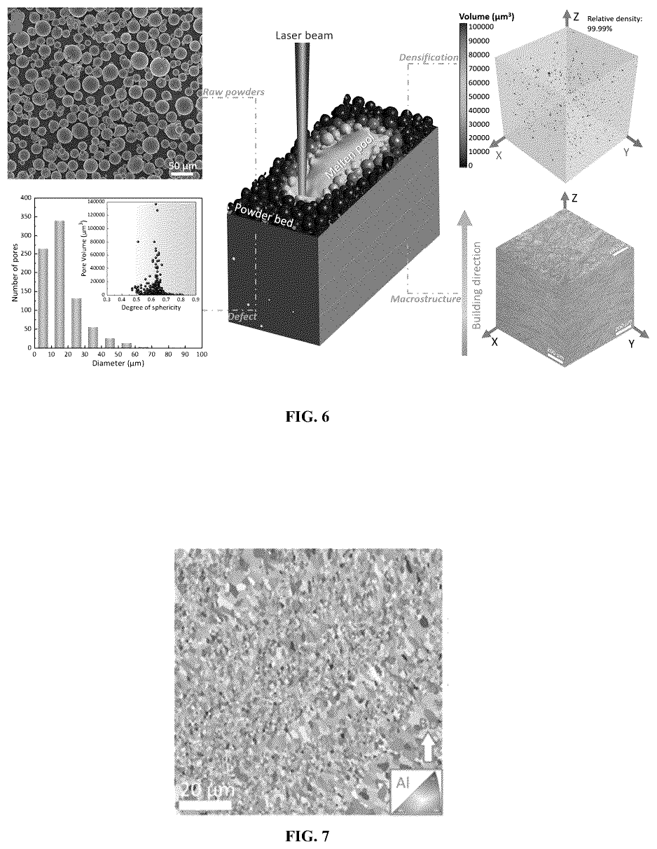

Raw powders with a chemical composition of Al-4.71Mg-0.85Mn-1.28Sc-0.56Zr (wt %) are produced for L-PBF through ultrasonic gas atomization (GA) using a 50-kg ingot. As shown in the upper left corner of FIG. 6, the raw powders have a mainly spherical morphology with only some tiny satellites attached to the surface, which is regarded as an inherent feature during the GA powder preparation process.

The X-ray microcomputed tomography (μ-CT) reconstruction volume image of the as-printed Al—Mg—Mn—Sc—Zr alloy is illustrated in the upper right corner of FIG. 6. A crack-free and highly dense Al—Mg—Mn—Sc—Zr alloy with a relative density of 99.99% is achieved by optimizing the processing parameters during the L-PBF of Al-4.71Mg-0.85Mn-1.28Sc-0.56Zr (wt %) powders.

The bottom left of FIG. 6 presents the distribution statistics of the internal pore size and degree of sphericity derived from the μ-CT data, showing that although the pore size ranged from 0 to 90 μm, more than 70% of the pores are smaller than 20 μm. Although there is some variation in pore size, most of the pores exhibited a high degree of sphericity, exceeding 0.5, suggesting that they are primarily gas pores, predominantly formed due to voids in the feedstock powders. This type of pore is considered the most common defect in L-PBFed alloys and is unlikely to be completely eliminated.

The optical macrograph of the as-printed sample (the bottom right of FIG. 6) reveals peacock-tail-like molten pools, approximately 250 μm in width and 100 μm in depth, demonstrating high-quality interlayer bonding during the printing process.

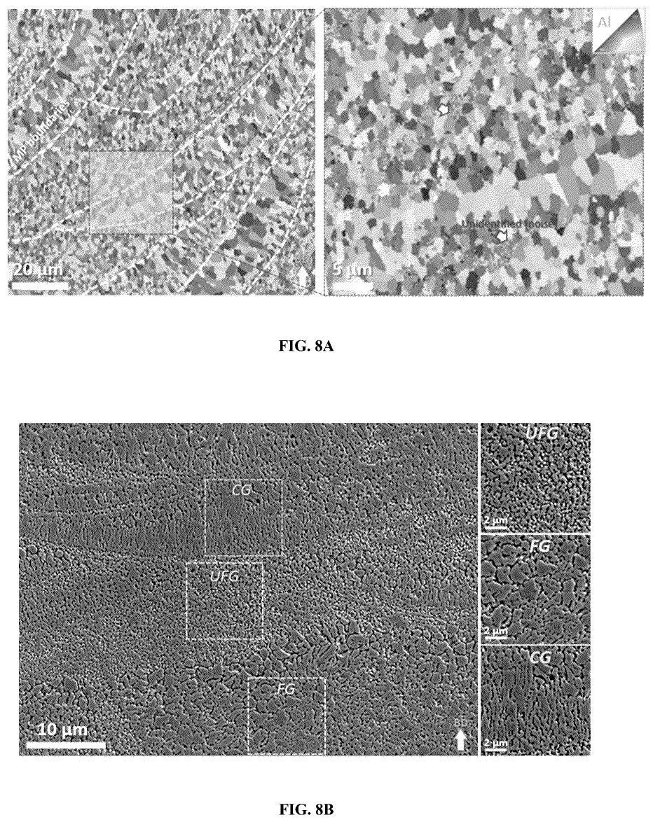

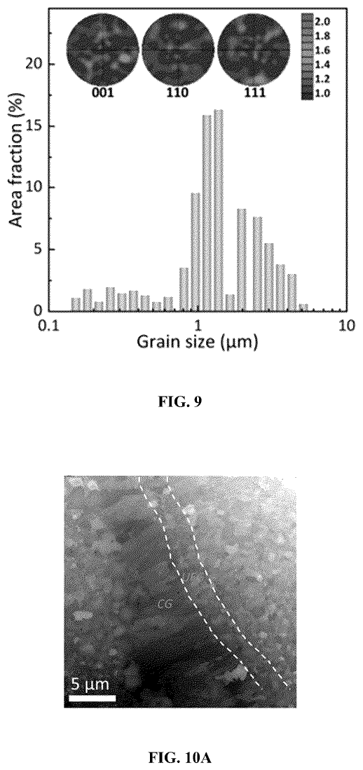

The longitudinal microstructure of the as-printed Al—Mg—Mn—Sc—Zr alloy, characterized by a hierarchically fine and heterogeneous structure, is examined. FIG. 7 shows the longitudinal electron back-scattered diffractometer (EBSD) images and FIGS. 8A-8B show scanning electron microscope (SEM) images. Both reveal a triple-modal grain distribution, including the cyclical modules of CG regions, FG regions and UFG regions. The UFG regions, with an average grain size of approximately 360 nm (FIG. 9), are located at the boundaries of the molten pools (MP) and are separated by fine-grained and coarse-grained regions. The FG regions have a grain size ranging from 0.7 to 2 μm whereas the CG regions are larger, with lengths of approximately 2 to 5 μm and widths of about 0.6 to 2 μm.

Referring to FIG. 9, the pole figure (PF) maps reveal a random grain orientation, indicating a weak texture in the as-printed sample.

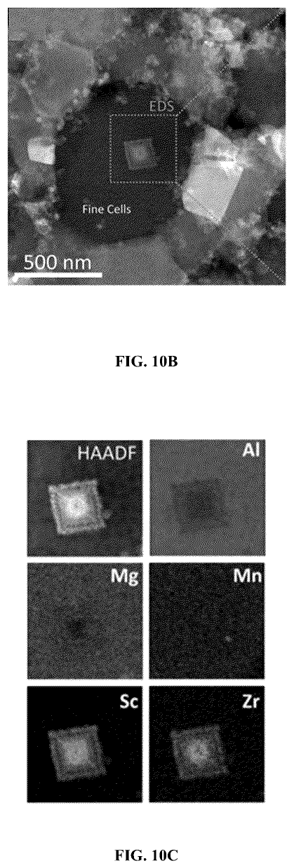

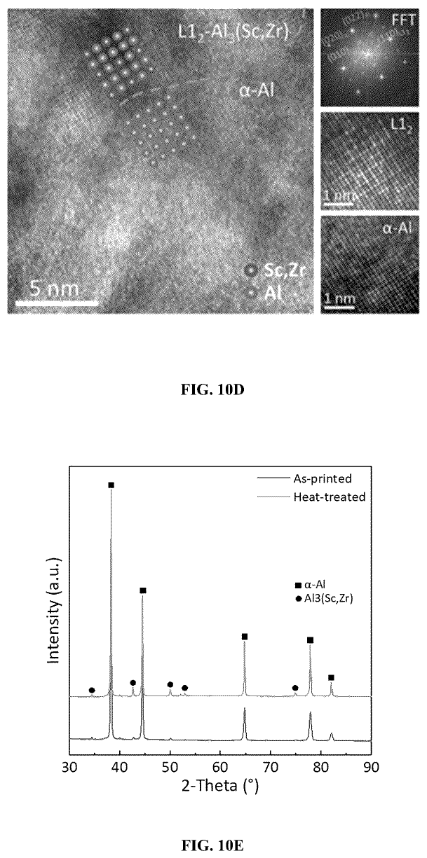

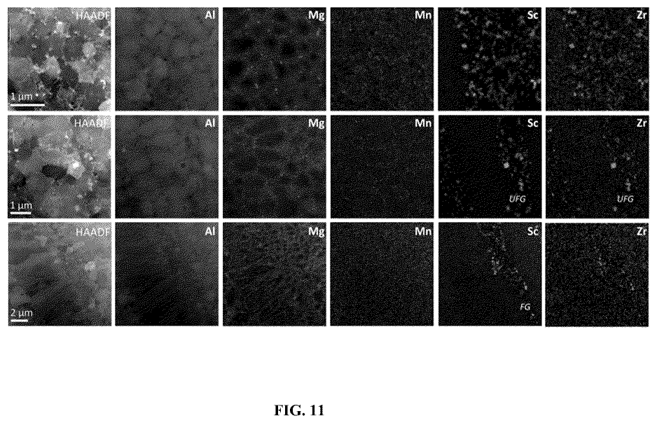

Referring to FIG. 10A, the TEM image further confirms the hierarchically heterogeneous microstructure with cubic particles observed within the grains (FIG. 10B). These cubic particles, rich in Sc and Zr (as shown in the energy-dispersive spectroscopy EDS mapping in FIG. 10C), are identified as Al₃(Sc, Zr) precipitates with an L1₂-ordered structure (FIG. 10D and FIG. 10E).

The fully coherent interface between the α-Al matrix and L1₂-Al₃(Sc, Zr) precipitates is formed due to the small atomic misfit and interplanar mismatch, confirming the role of these L1₂-Al₃(Sc, Zr) precipitates as nucleants that promote the formation of ultrafine-grained microstructures.

To examine the chemical and phase distributions in the as-printed heterogeneous microstructures, TEM and corresponding EDS analyses are performed on different regions.

Referring to FIG. 11, all the GBs are enriched with Mg and Mn. The Al₃(Sc, Zr) particles are absent in the CG regions but are extensively present in the UFG regions at the MP boundaries, further confirming their role as nucleation sites for α-Al during rapid cooling. As solidification progresses inward from the molten pool boundaries during L-PBF, the CG regions develop via epitaxial growth, with nucleation suppressed by the complete trapping of Sc/Zr. The formation of FG regions is likely due to the partial capture of Sc/Zr, leading to the presence of Al₃ (Sc, Zr) precipitates. Therefore, the uneven precipitation of the primary Al₃(Sc, Zr) particles under fast cooling is the primary cause for the hierarchically heterogeneous microstructure.

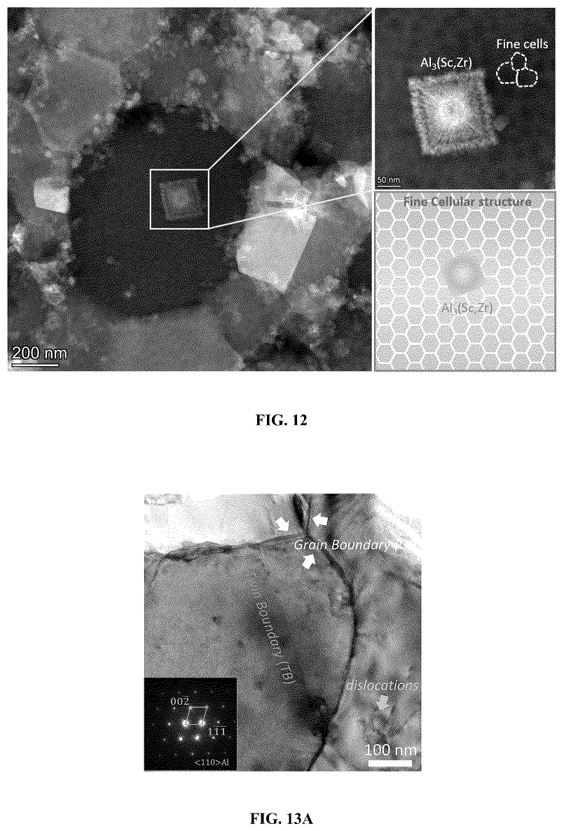

Furthermore, ultrafine cells with a size of approximately 40 nm are observed (FIG. 12) within the grains. These unique cellular structures, which typically do not form through conventional metallurgical methods, have been shown to effectively enhance the mechanical properties of various L-PBFed alloy systems. Such structures help accommodate excessive mobile dislocations during straining, contributing to the achievement of a strong synergy between high strength and ductility in Al alloys during deformation.

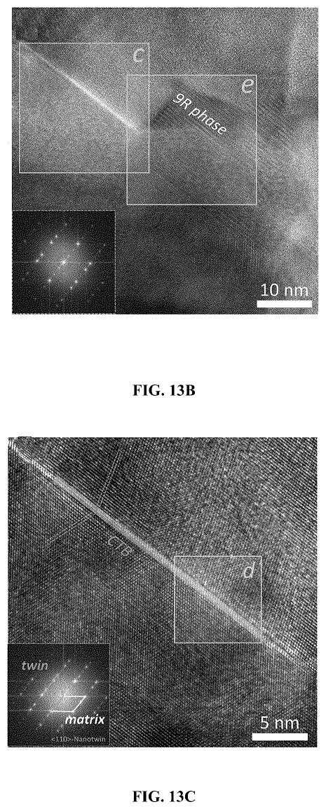

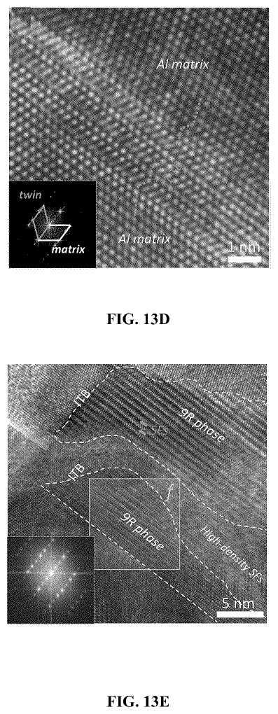

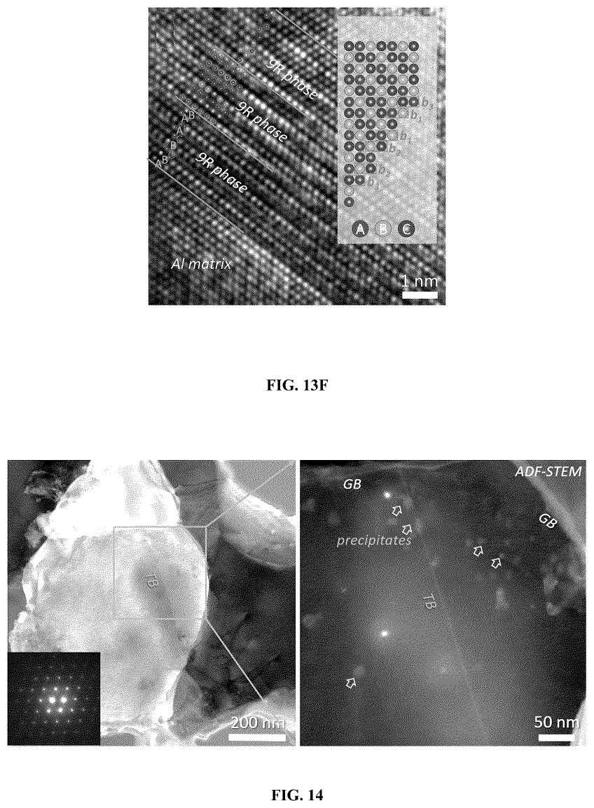

Referring to FIGS. 13A-13F, high-magnification images reveal detailed microstructures, with straight lines present within a single grain, which are suspected to be twin boundaries (FIG. 13A, FIG. 14). The high-resolution TEM images (FIGS. 13B-13F) unveil the presence of SFs, 9R phase and CTB. The 9R structure, which typically consists of three Shockley partial dislocations-one edge and two mixed partials-on adjacent {111}planes (FIG. 13F), is further validated by the FFT pattern (FIG. 13E).

Additionally, incoherent twin boundary (ITB) steps are observed in FIG. 13E, confirming that the formation of the 9R phase is associated with the dissociation and migration of part of the ITB in the twins. The 9R phase is therefore commonly considered a result of the extension of the ITB.

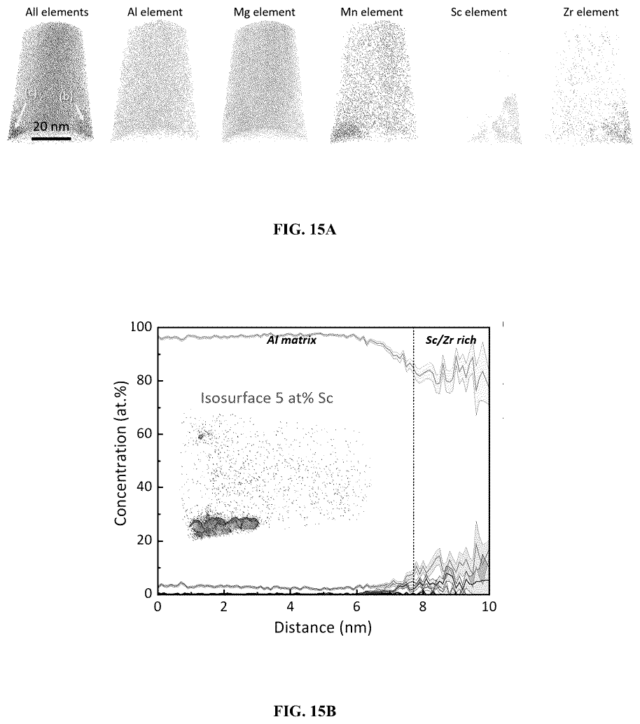

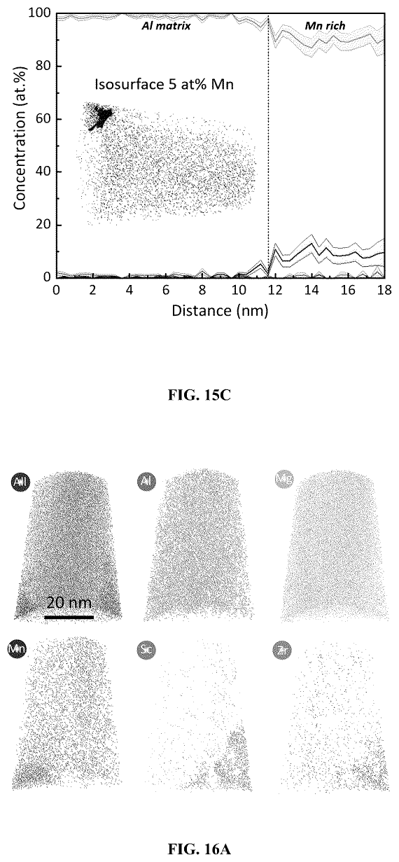

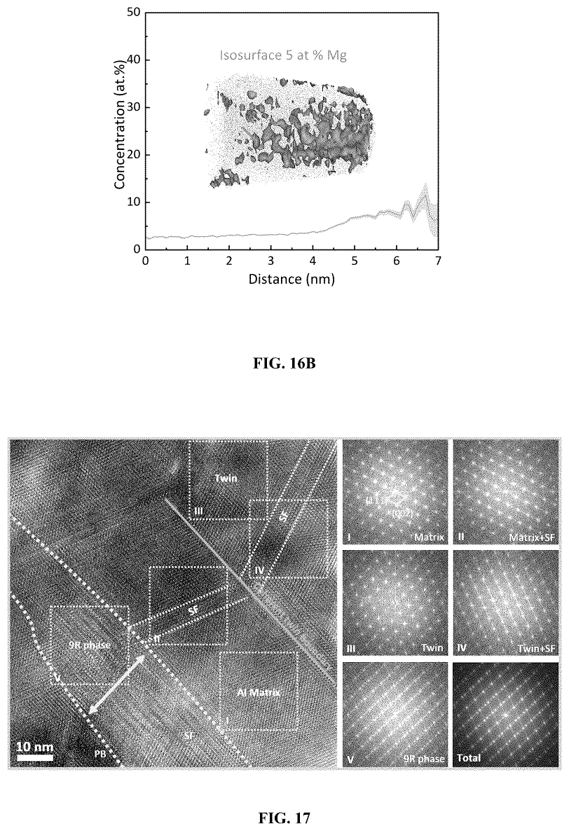

To examine the intragranular distribution and spatial morphology of elements at the atomic scale, 3D atomic probe tomography (APT) characterization is performed. Mn-rich regions, likely corresponding to the Al₆Mn phase, and Sc/Zr-rich regions, presumably corresponding to the L1₂-ordered phase, are observed (FIGS. 15A-15C). However, no significant segregation of Al and Mg elements is detected (FIG. 16A). Subsequent isosurface analysis and proxigram calculations revealed that the Mg content averaged approximately 4.1 at % as a solute, with noticeable chemical fluctuations (FIG. 16B), resulting in a region with varying SFE.

In FCC metals and alloys, mechanical twinning typically occurs in systems with low stacking fault energy (SFE), generally below 50 μmJ/m². As a result, the observation of the 9R phase in Al alloys is relatively rare due to their high SFE, which leads to a higher formation energy compared to nanotwins. Nevertheless, the rapid thermal cycles of the L-PBF process generate high internal stresses and promote element segregation in the as-printed alloy, creating an effective pathway for the formation of nanotwins and the 9R phase. In the present invention, the addition of Mg solute to Al alloys reduces the SFE, thereby facilitating the formation of nano-planar defects (such as SFs, twins, and the 9R phase) during the L-PBF process. In the as-printed Al—Mg—Mn—Sc—Zr alloy, the ITBs promote nucleation by facilitating the synchronized emission of three Shockley partials from a low SFE, Mg-rich region.

Furthermore, the reduced SFE gradient in the Al matrix, induced by the high Mg content during rapid cooling (FIGS. 16A-16B), facilitates the splitting of ITBs and the formation of the 9R phase under straining.

Therefore, the formation of nano-scaled planar defects in the as-printed Al alloys is closely linked to the synergistic effect of the reduced SFE from the high Mg solute content and the complex stress field generated during L-PBF. This also suggests that L-PBF can serve as an effective alternative, alongside severe plastic deformation, for directly introducing these planar defects into bulk Al alloys.

### Example 5

### Effect of Direct Ageing on the Microstructure and Strengthening Mechanisms of L-PBFed Al—Mg—Mn—Sc—Zr Alloy

To enhance the precipitation strengthening effect, the as-printed samples undergo direct aging at 300° C. for 4 hours. Referring to FIG. 17, the planar strengthening defects, including SFs, nanotwins, and the 9R phase, remain intact after heat treatment, indicating their high thermal stability. The figure illustrates the 9R phase, Al matrix, and SFs, with the CTB marked by the green line.

The corresponding FFT patterns of various regions are also provided to identify the feature combinations. The left and right sections of the 9R phase correspond to the Al matrix and the twin, with a variety of SFs also observed.

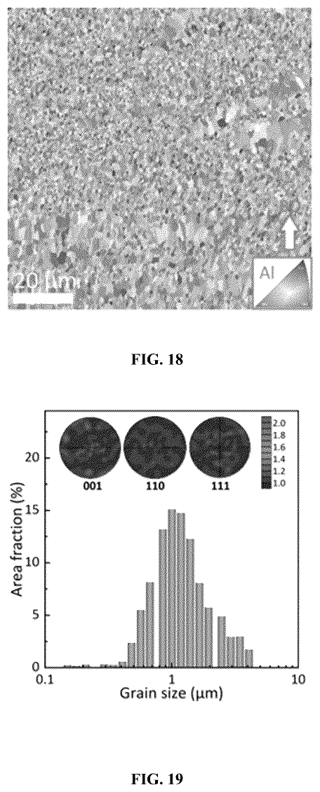

Referring to FIG. 18, the heat-treated Al—Mg—Mn—Sc—Zr alloy retains the triple-modal grain size distribution observed in the as-printed alloy. In contrast to conventional heat treatments of Al alloys (e.g., solution+aging treatments), the direct aging process at a relatively low temperature of 300° C. in this invention does not result in significant grain coarsening. This suggests that the alloy exhibits excellent thermal stability, allowing the GB strengthening, as predicted by the Hall-Petch relationship, to be effectively maintained in the heat-treated state.

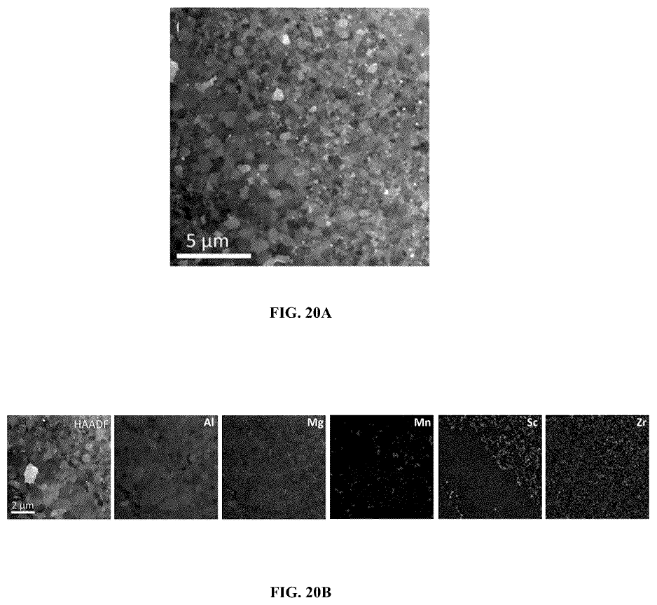

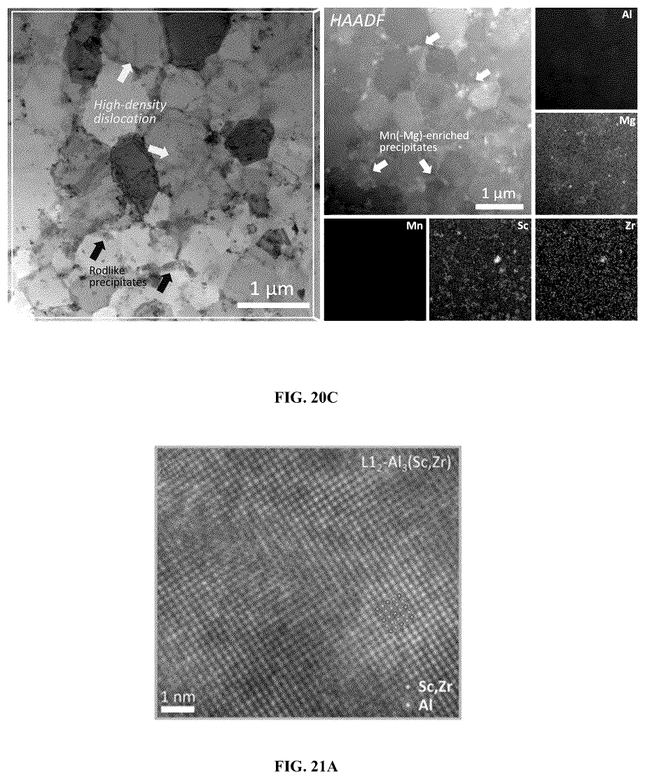

Additionally, the microstructure of the heat-treated alloy shows almost no texture (FIG. 19), indicating that the alloy exhibits near-isotropic mechanical properties. The TEM images of the heat-treated alloy in FIGS. 20A-20B reveal a considerable number of nanoprecipitates. Two main types of the fine particles are detected in the EDS results (FIGS. 20B-20C): (1) Al—Mn—(Mg)-rich and (2) Al—Sc—Zr-rich precipitates. The rod-shaped Al—Mn—(Mg)-rich phases are identified as Al₆Mn phase, which are commonly observed strengtheners that pin both GBs and dislocations in the L-PBFed and wrought Al—Mn-based alloys.

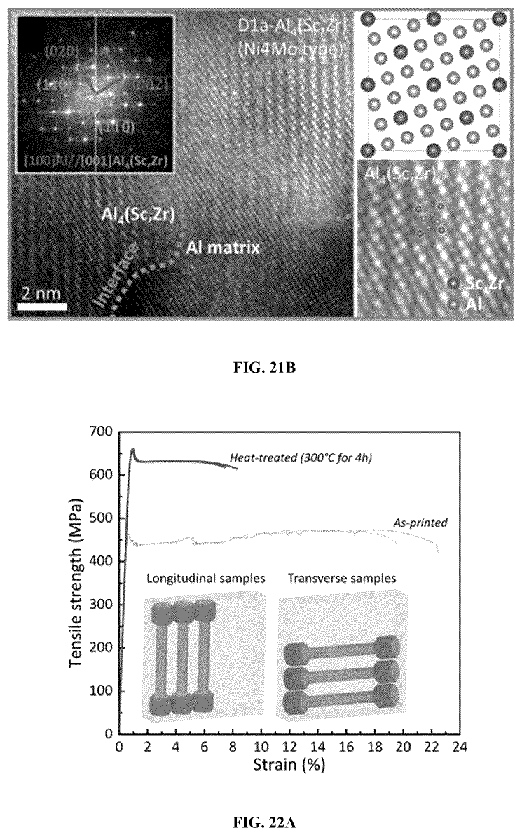

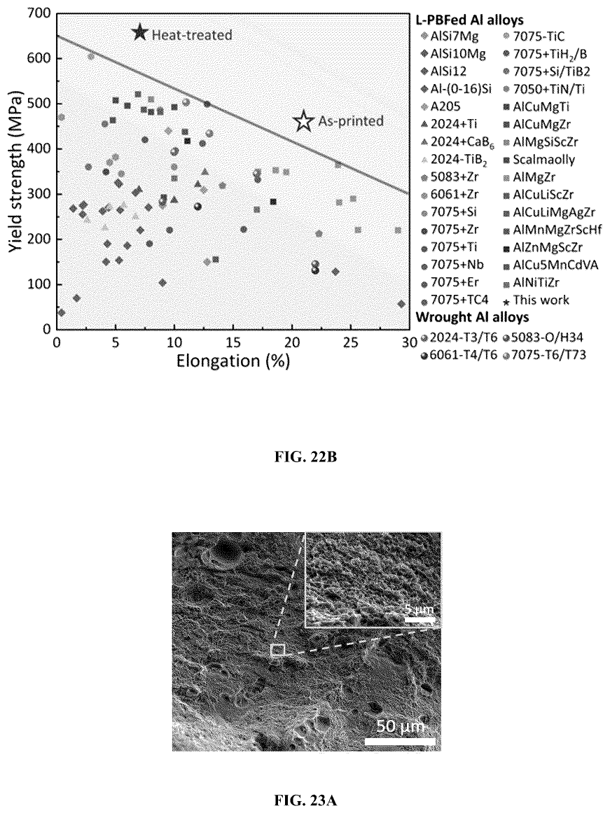

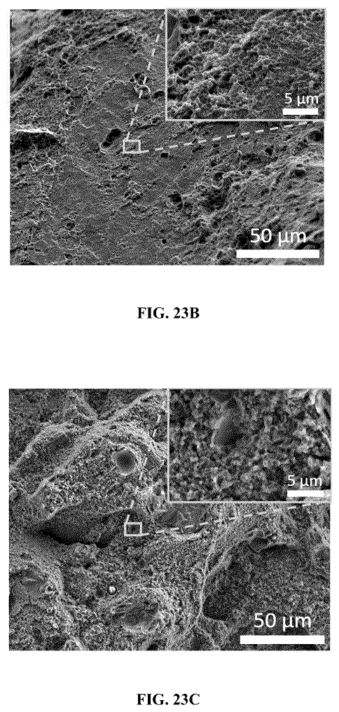

In addition to the primary L1₂-Al₃(Sc, Zr) phase (FIG. 21A) and secondary L1₂-Al₃ (Sc, Zr) phase, D1a-ordered Al₄ (Sc,Zr) phases (Ni₄Mo-type) are also observed, forming a semi-coherent interface with the Al matrix, as shown in FIG. 21B.

### Example 6

Mechanical Performance of as-Printed and Heat-Treated Al—Mg—Mn—Sc—Zr Alloys

Turning to FIGS. 22A-22B, the mechanical performance of the as-printed and heat-treated Al—Mg—Mn—Sc—Zr samples is shown. The samples exhibit isotropic tensile strength and ductility, demonstrating consistent mechanical behavior in all directions (FIG. 22A). The as-printed samples demonstrate a high yield strength (YS) of around 461 MPa and an elongation (EL) of about 21% in both directions. The tensile stress-strain curves of the as-printed samples show serrations, characteristic of the Portevin-Le Chatelier (PLC) effect, which is typically associated with the interaction between solute atoms (e.g., Mg and Mn) in the matrix and the mobile dislocations.

Turning to FIG. 22B, which compares the tensile performance of the present Al—Mg—Mn—Sc—Zr alloys with other high-strength Al alloys fabricated by L-PBF and traditional process. Both the as-printed and heat-treated Al—Mg—Mn—Sc—Zr alloys exhibit an exceptional combination of strength and ductility. Notably, the heat-treated sample achieved the highest YS among all L-PBF Al alloys and conventional high-strength wrought Al alloys, along with an EL of approximately 7.2%. This makes it suitable for a wide range of applications, especially in comparison to other L-PBF high-strength Al alloys, which offer similar strength levels but display inferior ductility. Additionally, the relatively low density of this newly developed Al—Mg—Mn—Sc—Zr alloy (around 2.72 g/cm³) offers a high specific strength, making it an appealing choice for high-strength, lightweight applications.

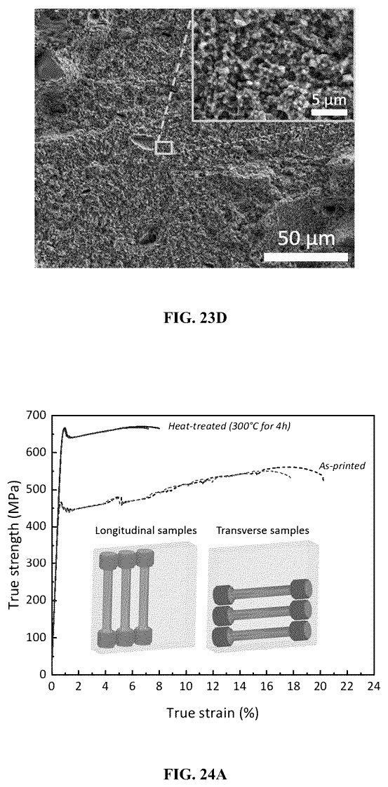

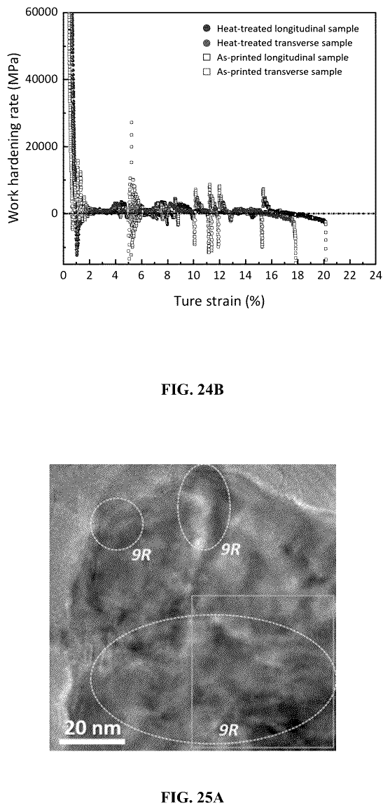

In contrast, the heat-treated samples exhibit a YS of approximately 656 MPa and a respectable EL of around 7.2%, with the PLC phenomenon no longer observed. This can be attributed to the consumption of solute atoms, which form nanoprecipitates during the direct ageing treatment. Referring to FIGS. 23A-23D, the fractographies of the L-PBFed samples reveal densely packed submicron equiaxed dimples in both the as-printed and heat-treated conditions, indicating ductile fracture behavior.

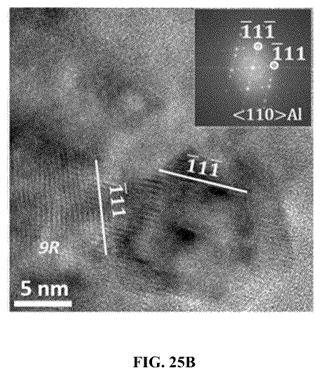

It is also observed that both the as-printed and heat-treated Al alloys exhibit discontinuous yielding during deformation, characterized by a slight yield drop (referred to as the yield point phenomenon), followed by limited work hardening (FIGS. 24A-24B). The unusual yield point phenomenon has been observed in various metallic materials (e.g., Ni-based superalloys, steels, Mg alloys, and Al alloys) with specific microstructures. This behavior is primarily attributed to the absence of mobile dislocations, which are strongly pinned by solute atoms. In the present invention, the pinning of dislocations is enhanced by the elastic field interactions between the solute clusters (such as Mg and Mn) or solute atmosphere and the moving dislocations. The differences in the shear modulus and atomic size of the solute clusters or solute atmosphere within the Al matrix can create local strain fields, which interact with moving dislocations and restrict their motion along slip planes. As straining continues, dislocations are released, causing a sudden drop in stress until the dislocations are pinned again by the solute clusters or atmosphere. This results in the yield point phenomenon observed in the present alloys. Conversely, the restricted work hardening is primarily due to the highly refined grains, which result in increased interactions between dislocations and a high density of GBs. Because of the abundance of grain boundaries, the dislocations generated by tensile straining cannot effectively accumulate or be stored within the grains to enhance work hardening. Instead, these dislocations are either annihilated by other dislocations or absorbed into the grain boundaries.

### Example 7

### Underlying Mechanisms of the Excellent Mechanical Performance of the L-PBFed Al—Mg—Mn—Sc—Zr Alloys

To establish the correlation between microstructures and high strength and ductility, the heat-treated Al alloy is used as an example to discuss the various strengthening mechanisms.

Direct ageing treatment introduces a significant number of nano-precipitates, which further enhance the precipitation hardening response by inhibiting dislocation movement. Additionally, the nano-sized defects, such as SFs, and the notable presence of the 9R phase, as shown in the deformed as-printed and heat-treated Al alloys (FIG. 25), continue to contribute to mechanical strengthening. This is achieved through their resistance to dislocation propagation via lattice distortion at interfaces and by acting as barriers to dislocation motion.

Furthermore, significant strengthening effects have been observed from as-grown twins and the 9R phase in studies of nanotwinned Al—Mg thin films and Y-bearing nanograined Al—Mg alloys produced through mechanical alloying. These findings highlight the complex interplay of these planar defects in determining the tensile strengths of these high-performance Al alloys.

Therefore, the high strength of the heat-treated Al alloy primarily results from: (i) the formation of strengthening features, such as nanoparticles and nano-scale planar defects; (ii) grain boundary strengthening due to grain refinement; (iii) solution strengthening from the supersaturated solid solution formed during L-PBF; and (iv) a relative density of up to 99.99%.

To understand the origins of the high strength achieved through the newly developed alloy design strategy, the underlying strengthening mechanisms are outlined. The heat-treated Al alloys are quantitatively discussed as an example to elucidate the various strengthening mechanisms.

### (i) Grain Boundary Strengthening

The refined microstructure was achieved in the as-printed sample, while there was no significant change in grain size after the direct ageing process. The strength contribution from grain boundary strengthening is estimated using the classical Hall-Petch relationship:

$${σ}_{G B} = {σ}_{0} + {φ}_{UFG} {k}_{y} {d}_{UFG}^{- 1 / 2} + {φ}_{F G} {k}_{y} {d}_{F G}^{- 1 / 2} + {φ}_{C G} {k}_{y} {d}_{C G}^{- 1 / 2} \qquad ( 1 )$$

where σ₀ denotes the intrinsic resistance of the Al lattice to dislocation motion (20 MPa), k_{y} is the Hall-Petch strengthening coefficient (around 0.12-0.14 MN/m^{3/2} for Al alloys). The φ_{UFG} (around 31.9%), φ_{FG} (around 55.9%), and φ_{CG} (around 12.2%) are the area fractions of the UFG region, FG region and CG region in the heat-treated sample, respectively. Similarly, d_{UFG} (0.68×10⁻⁶ μm), d_{FG} (1.08×10⁻⁶ μm), and d_{CG}(2.84×10⁻⁶ μm) correspond to the average grain sizes (in meter) of the UFG, FG and CG.

As a result, the estimated yield strength increment attributed to the GB strengthening for the heat-treated alloy is 140 to 160 MPa.

### (ii) Solid Solution Strengthening

Solid-solution strengthening occurs when the elements are alloyed with a metal matrix as solute atoms that differ from the matrix atoms in size and/or shear modulus, which many cause a variation of strain fields. It has been generally acknowledged that the contribution of solid solution strengthening to the yield strength increment is described by the Fleischer equation:

$$Δ {σ}_{SS} = {M ( \frac{3}{8} )}^{2 / 3} {( \frac{1 + v}{1 - v} )}^{4 / 3} {( \frac{ω}{b} )}^{1 / 3} G {ε}^{4 / 3} {c}^{2 / 3} \qquad ( 2 )$$

where M indicates the average Taylor factor (or mean orientation factor, 3.06 for Al) that correlates the yield stress to the critical resolved shear stress. v denotes the Poisson's ratio (0.33 for Al). ω=5b, and b represents the magnitude of the Burgers vector. G and ε are the shear modulus and the lattice misfit strain, respectively. c is the atomic fraction of the solute elements in the Al matrix.

Based on the equilibrium solid solubility of alloying elements in α-Al at 300° C., specifically 3.45 wt % Mg, 0.02 wt % Mn, 0.003 wt % Sc, 0.001 wt % Zr, and 0.002 wt % Hf, as calculated using Thermo-Calc software, the estimated yield strength increment in the heat-treated alloy is approximately 57 MPa.

(iii) Precipitate Strengthening

There are a large number of precipitations in the heat-treated sample, such as the L1₂-ordered Al₃(Sc,Zr) and Al₆Mn precipitates. It has been reported that the critical radius leading to the transition from precipitate shearing to the Orowan dislocation looping mechanism for the L1₂-structured particle is 2.1 nm. The strength increment by Orowan looping could be calculated by:

$$Δ {σ}_{O r o w a n} = M \frac{0.4 Gb}{π \sqrt{1 - v}} \frac{ln ( 2 \overline{r} / b )}{{λ}_{p}} \qquad ( 3 )$$

where M, G, v, b are mean orientation factor (3.06 for Al), shear modulus (26.9 GPa), Poisson's ratio (0.33), and magnitude of the Burgers vector (0.286 nm), respectively. r̅ is the mean radius of a spherical precipitate in a circular cross section in a random plane, and can be estimated using the following equation:

$$\overline{r} = ( \sqrt{\frac{2}{3}} r ) \qquad ( 4 )$$

where r is the mean radius of the precipitates. λₚ denotes the mean edge-to-edge inter-precipitate spacing (nm), which can be calculated by:

$${λ}_{p} = 2 \overline{r} ( \sqrt{\frac{π}{4 φ}} - 1 ) \qquad ( 5 )$$

where φ is the volume fraction of the precipitate.

In the heat-treated sample, the volume fraction of Al₆Mn precipitates is approximately 1.84%, with a width of 74±14 nm and a length of 619±122 nm, contributing to a strength increment of around 13 MPa. The primary L1₂-ordered phase, with a volume fraction of approximately 1.84% and an equivalent radius of 147±33 nm, and the secondary L1₂-ordered phase, with a volume fraction of around 1.22% and a mean radius of 2.9±0.9 nm, are observed, resulting in strength increments of approximately 20 MPa and 309 MPa, respectively. Therefore, the total calculated strength increment from precipitate strengthening is about 342 MPa.

### (iv) Nano-Sized Planar Defects Strengthening

It is generally uncommon to introduce planar defects such as SFs and nanotwins in bulk aluminum alloys. However, in the present work, these defects were observed in both the as-printed and heat-treated samples. The high density of SFs in the form of the 9R phase contributes to strengthening to some extent. Specifically, the SFs and 9R phase can hinder dislocation emission due to the induced lattice distortion and also act as strong barriers to dislocation motion. Taking into account grain boundary strengthening (around 140-160 MPa), solid solution strengthening (around 57 MPa), precipitate strengthening (around 342 MPa), and the baseline strength of pure Al (around 60 MPa), the calculated yield strength is approximately 599-619 MPa. Compared to the experimental value (around 656 MPa), the additional strength increment of about 37-57 MPa is attributed to the strengthening effects of nano-sized planar defects. The quantitative calculation results clarify that the main strengthening mechanisms contributing to the high yield strength of the heat-treated sample are grain boundary strengthening (approximately 140-160 MPa), solid solution strengthening (approximately 57 MPa), precipitation strengthening (approximately 342 MPa), and strengthening from nano-sized planar defects (approximately 37-57 MPa). These results highlight the predominant role of nanoprecipitates in the overall strengthening. This also suggests the potential for introducing nano-sized planar defects to achieve optimal strengthening in the present bulk Al alloys. Therefore, it is anticipated that higher strength can be achieved by tuning the planar defects and/or nanoprecipitates (e.g., density and size) through a coordinated approach of composition optimization (e.g., increasing Mg content) and heat treatment strategies.

In addition to its satisfactory mechanical strength, the heat-treated sample also demonstrated a commendable tensile ductility of approximately 7.2%. This is primarily attributed to the hierarchically fine, heterogeneous microstructure, which features a triple-modal grain distribution. Such a unique heterogeneous microstructure leads to a simultaneous improvement in strength and ductility through the combination of softer CG zones and harder FG zones (UFG and FG regions in the present invention). The strain is primarily localized within the CG zones, as they exhibited greater dislocation plasticity compared to the FG zones during deformation. Thus, micro-cracks are expected to nucleate at the interfacial regions when large strain inhomogeneity occurs, resulting in delamination fracture. This phenomenon is strongly associated with the stabilization of tensile deformation and the enhancement of tensile ductility.

Furthermore, the presence of high-density secondary L1₂-ordered Al₃ (Sc, Zr) precipitates, uniformly distributed in the Al matrix, plays a crucial role in enhancing ductility. The coherent interfaces between the FCC-Al matrix and the L1₂-ordered nanoprecipitates are key to facilitating the nanoscale homogenization of the plastic flow and internal stress fields.

This coherence effectively hinders or delays micro-crack nucleation due to the elastic compatibility between the two phases, significantly contributing to the material's ductility. This underscores the importance of these nanoprecipitates in enhancing the mechanical properties of the alloy.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments are chosen and described in order to best explain the principles of the invention and its practical application, thereby enabling others skilled in the art to understand the invention for various embodiments and with various modifications that are suited to the particular use contemplated.

### Definition

Throughout this specification, unless the context requires otherwise, the word “comprise” or variations such as “comprises” or “comprising”, will be understood to imply the inclusion of a stated integer or group of integers but not the exclusion of any other integer or group of integers. It is also noted that in this disclosure and particularly in the claims and/or paragraphs, terms such as “comprises”, “comprised”, “comprising” and the like can have the meaning attributed to it in U.S. Patent law; e.g., they allow for elements not explicitly recited, but exclude elements that are found in the prior art or that affect a basic or novel characteristic of the present invention.

Furthermore, throughout the specification and claims, unless the context requires otherwise, the word “include” or variations such as “includes” or “including”, will be understood to imply the inclusion of a stated integer or group of integers but not the exclusion of any other integer or group of integers.

References in the specification to “one embodiment”, “an embodiment”, “an example embodiment”, etc., indicate that the embodiment described can include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

As used herein, terms “approximately”, “basically”, “substantially”, and “about” are used for describing and explaining a small variation. When being used in combination with an event or circumstance, the term may refer to a case in which the event or circumstance occurs precisely, and a case in which the event or circumstance occurs approximately. As used herein with respect to a given value or range, the term “about” generally means in the range of ±10%, ±5%, ±1%, or ±0.5% of the given value or range. The range may be indicated herein as from one endpoint to another endpoint or between two endpoints. Unless otherwise specified, all the ranges disclosed in the present disclosure include endpoints. When reference is made to “substantially” the same numerical value or characteristic, the term may refer to a value within ±10%, ±5%, ±1%, or ±0.5% of the average of the values.

In the methods of preparation described herein, the steps can be carried out in any order without departing from the principles of the invention, except when a temporal or operational sequence is explicitly recited. Recitation in a claim to the effect that first a step is performed, and then several other steps are subsequently performed, shall be taken to mean that the first step is performed before any of the other steps, but the other steps can be performed in any suitable sequence, unless a sequence is further recited within the other steps. For example, claim elements that recite “Step A, Step B, Step C, Step D, and Step E” shall be construed to mean step A is carried out first, step E is carried out last, and steps B, C, and D can be carried out in any sequence between steps A and E, and that the sequence still falls within the literal scope of the claimed process. A given step or sub-set of steps can also be repeated. Furthermore, specified steps can be carried out concurrently unless explicit claim language recites that they be carried out separately.

The term “laser powder bed fusion (L-PBF)” refers to a metal additive manufacturing technique that uses a high-power laser to selectively melt and fuse layers of metallic powder to produce components with complex geometries.

The term “triple-modal grain distribution” refers to a grain structure characterized by three distinct size regions: ultrafine-grained (UFG, grain size<500 nm), fine-grained (FG, grain size 0.1-2 μm), and coarse-grained (CG, grain size 1-5 μm).

The term “nano-scale planar defects” refers to structural irregularities within the crystal lattice at the nanoscale, including stacking faults, nanotwins, and the 9R phase, which enhance the mechanical properties by impeding dislocation motion.

The term “stacking fault energy (SFE)” refers to a measure of the energy required to create a stacking fault in a crystal lattice, influencing the formation of planar defects such as stacking faults and nanotwins.

The term “9R Phase” refers to a specific crystalline structure consisting of nine atomic layers with an . . . ABC/BCA/CAB/A . . . stacking sequence, typically stabilized by Mg-enriched regions in aluminum alloys.

The term “L1₂-ordered Al₃(Sc, Zr) nanoprecipitates” refers to nanometer-sized precipitates with an ordered cubic crystal structure, formed from aluminum, scandium, and zirconium, that provide nucleation sites and enhance mechanical properties through precipitation strengthening.

The term “heterogeneous nucleation” refers to the formation of new crystal phases initiated at specific sites, such as precipitates, that lower the energy barrier for nucleation.

Other definitions for selected terms used herein may be found within the detailed description of the present invention and apply throughout. Unless otherwise defined, all other technical terms used herein have the same meaning as commonly understood to one of ordinary skill in the art to which the present invention belongs.

What is claimed is:

1. A high-strength, fine-grained aluminum alloy microstructure, comprising an alloy composition of AlₓMg_{y}ScᵤZr_{y}, wherein:
0.70≤x≤0.95, 0.04≤y≤0.20, 0.005≤u≤0.05, 0.005≤v≤0.05,
wherein the aluminum alloy microstructure exhibits a triple-modal grain distribution comprising ultrafine-grained (UFG) regions, fine-grained (FG) regions, and coarse-grained (CG) regions, and wherein the aluminum alloy microstructure further comprises nano-scale planar defects, including stacking faults, nanotwins, and the 9R phase, distributed throughout an aluminum matrix.

2. The high-strength, fine-grained aluminum alloy microstructure of claim 1, wherein the UFG regions have an average grain size of less than 500 nm and are positioned along the molten pool boundaries within the aluminum alloy microstructure.

3. The high-strength, fine-grained aluminum alloy microstructure of claim 1, wherein the FG regions have an average grain size ranging from 0.1 μm to 2 μm, and the CG regions have an average grain size ranging from 1 μm to 5 μm.

4. The high-strength, fine-grained aluminum alloy microstructure of claim 1, wherein the aluminum alloy microstructure further comprises a dispersion of L1₂-ordered Al₃(Sc,Zr) nanoprecipitates distributed in the aluminum matrix, providing precipitation strengthening to the aluminum alloy microstructure.

5. The high-strength, fine-grained aluminum alloy microstructure of claim 4, wherein the L1₂-ordered Al₃(Sc,Zr) nanoprecipitates serve as heterogeneous nucleation sites during solidification, resulting in the triple-modal grain distribution.

6. The high-strength, fine-grained aluminum alloy microstructure of claim 4, wherein the CG regions exhibit limited dislocation mobility and enhanced resistance to crack propagation due to the presence of L1₂-ordered Al₃(Sc,Zr) nanoprecipitates.

7. The high-strength, fine-grained aluminum alloy microstructure of claim 1, wherein the nano-scale planar defects remain intact following direct aging treatment at approximately 300° C.

8. The high-strength, fine-grained aluminum alloy microstructure of claim 1, wherein the aluminum alloy microstructure provides a relative density of at least 99%.

9. The high-strength, fine-grained aluminum alloy microstructure of claim 1, wherein the UFG regions, the FG regions, and the CG regions collectively contribute to a yield strength of at least 656 MPa and an elongation of at least 7.2% under a heat-treated condition.

10. The high-strength, fine-grained aluminum alloy microstructure of claim 1, wherein the 9R phase is stabilized by Mg-enriched regions in the aluminum matrix.

11. The high-strength, fine-grained aluminum alloy microstructure of claim 1, wherein the aluminum alloy microstructure is manufactured by laser powder bed fusion (L-PBF), the nano-scale planar defects are formed under rapid thermal cycles unique to the L-PBF process.

12. The high-strength, fine-grained aluminum alloy microstructure of claim 1, wherein the alloy composition further comprises manganese (Mn), forming AlxMgyScᵤZrᵥ, wherein 0.70≤x≤0.95, 0.04≤y≤0.20, 0.01≤z≤0.05, 0.005≤u≤0.05, 0.005≤v≤0.05.

13. A method of fabricating a high-strength, fine-grained aluminum alloy microstructure with nanostructured strengthening defects, comprising:
preparing one or more alloy powder comprising aluminum (Al), magnesium (Mg), scandium (Sc), and zirconium (Zr);
melting the one or more alloy powder on a preheated substrate using a laser powder bed fusion (L-PBF) process with a laser power of 300-400 W and scan speed of 800-2000 μmm/s to induce rapid cooling and grain refinement, resulting in the formation of nano-scale planar defects; and
forming a triple-modal grain distribution across as-printed aluminum alloy to obtain the high-strength, fine-grained aluminum alloy microstructure.

14. The method of claim 13, wherein the nano-scale planar defects and the triple-modal grain distribution are preserved after the direct treatment at 300° C. for 4 hours.

15. The method of claim 13, wherein the nano-scale planar defects comprise stacking faults, nanotwins, and the 9R phase, and the triple-modal grain distribution comprises columnar grain (CG) regions, fine grain (FG) regions and ultrafine grain (UFG) regions.

16. The method of claim 13, wherein the triple-modal grain distribution results from unevenly distribution of L1₂-ordered Al₃(Sc,Zr) nanoprecipitates, which form a coherent interface with an aluminum matrix and therefore promote heterogeneous nucleation of α-Al during solidification of melt pools in the PBF-LB process, and the L1₂-ordered Al₃(Sc,Zr) nanoprecipitates are mainly formed in the UFG regions.

17. The method of claim 13, wherein the one or more alloy powder further comprises manganese (Mn).

18. The method of claim 17, wherein the one or more alloy powder comprises:
70-95 wt % of Al,
4-20 wt % of Mg,
1-5 wt % of Mn,
0.5-5 wt % of Sc, and
0.5-5 wt % of Zr.

19. The method of claim 13, wherein the preheat temperature of the substrate is in the range of room temperature to 200° C., and the substrate comprises various grades of Al alloys.
